(19) United States
(12) Patent Application Publication
(10) Pub. No.: US 2025/0190472 A1
(43) Pub. Date: Jun. 12, 2025

(54) INFORMATION PROCESSING APPARATUS, INFORMATION PROCESSING METHOD, AND COMPUTER PROGRAM PRODUCT

(71) Applicant: KABUSHIKI KAISHA TOSHIBA, Tokyo (JP)

(72) Inventor: Shigeru MAYA, Edogawa Tokyo (JP)

(73) Assignee: KABUSHIKI KAISHA TOSHIBA, Tokyo (JP)

(21) Appl. No.: 18/768,348

(22) Filed: Jul. 10, 2024

(30) Foreign Application Priority Data
Dec. 11, 2023 (JP) 2023-208640

(51) Int. Cl. G06F 16/33

(52) U.S. Cl. CPC G06F 16/3347

(57) ABSTRACT

An information processing apparatus includes a processor. The processor calculates a degree of certainty expressed by a discrete value for each of one or more phrases included in a search criterion. The search criterion includes the phrases and one or more logical operators. The degree of certainty represents certainty of correlation between each of pieces of target information to be searched for and the phrases. The processor calculates a score for each of the phrases. The score is a continuous value obtained by converting degrees of similarity between the pieces of target information and the phrases. The score is calculated such that the degrees of similarity fall within a range determined for the degree of certainty. The processor converts the score calculated for each of the phrases into a conversion score in accordance with a conversion method determined for each of the logical operators.

### CROSS-REFERENCE TO RELATED APPLICATIONS

This application is based upon and claims the benefit of priority from Japanese Patent Application No. 2023-208640, filed on Dec. 11, 2023; the entire contents of which are incorporated herein by reference.

### FIELD

Embodiments of the present disclosure relate generally to an information processing apparatus, an information processing method, and a computer program product.

### BACKGROUND

In recent years, a technique of searching for information by using a representation vector has been proposed. In such a technique, each search word included in a search criterion and a document to be searched for are represented by a high-dimensional vector called the representation vector.

Various approaches for obtaining the representation vector have been proposed. Basically, learning is performed such that search words and documents each having similar meanings have similar representation vectors.

If only such a representation vector can be learned, for example, “deep machine learning” and “deep learning” can be expected to have similar representation vectors. Then, searching for a document having a representation vector similar to a representation vector of “deep machine learning” means searching for a document similar also to “deep learning”. Therefore, similar words can be widely handled.

The search criterion may include a plurality of search words. In this case, a complex search criterion including a logical operator such as AND, OR, and NOT can be described. In a search using a representation vector and using a complex search criterion including a logical operator, it is required that information matching the search criterion can be more appropriately searched for.

### BRIEF DESCRIPTION OF THE DRAWINGS

FIG. 1 is a block diagram of an information processing apparatus of a first embodiment;

FIG. 2 illustrates one example of a data structure of a document DB;

FIG. 3 illustrates one example of a data structure of a transposition index DB;

FIG. 4 illustrates one example of a data structure of a word vector DB;

FIG. 5 illustrates one example of a data structure of a document vector DB;

FIG. 6 illustrates one example of a data structure of a similarity DB;

FIG. 7 illustrates one example of a data structure of a certainty DB;

FIG. 8 illustrates one example of a data structure of a score DB;

FIG. 9 is a flowchart of search processing in the first embodiment;

FIG. 10 is a flowchart of certainty degree calculation processing;

FIG. 11 is a flowchart of score calculation processing;

FIG. 12 is a flowchart of score conversion processing;

FIG. 13 illustrates an example of a conversion score in a case of a search criterion including an AND operator;

FIG. 14 illustrates an example of a conversion score in a case of a search criterion including an OR operator;

FIG. 15 illustrates an example of a conversion score in a case of a search criterion including a NOT operator;

FIG. 16 is a block diagram of an information processing apparatus of a second embodiment;

FIG. 17 illustrates one example of a data structure of a feedback DB;

FIG. 18 is a flowchart of certainty degree calculation processing;

FIG. 19 is a block diagram of an information processing apparatus of a third embodiment;

FIG. 20 illustrates one example of an input screen; and

FIG. 21 is a hardware configuration diagram of the information processing apparatuses of the embodiments.

### DETAILED DESCRIPTION

An information processing apparatus according to an embodiment includes one or more hardware processors. The hardware processors are configured to calculate a degree of certainty expressed by a discrete value for each of one or more phrases included in a search criterion. The search criterion includes the one or more phrases and one or more logical operators. The degree of certainty represents certainty of correlation between each of pieces of target information to be searched for and the one or more phrases. The hardware processors are configured to calculate a score for each of the one or more phrases. The score is a continuous value obtained by converting degrees of similarity between the pieces of target information and the one or more phrases. The score is calculated such that the degrees of similarity fall within a range determined for the degree of certainty. The hardware processors are configured to convert the score calculated for each of the one or more phrases into a conversion score in accordance with a conversion method determined for each of the one or more logical operators.

Preferred embodiments of information processing apparatuses according to the present disclosure will be described in detail below with reference to the accompanying drawings.

In recent years, scales of storage devices have been getting larger with the progress of Internet of Things (IoT). An environment in which a wide variety of pieces of document data (hereinafter, also simply referred to as document) can be stored in a server has been prepared. Accordingly, there is an increasing demand of selecting a document corresponding to a search criterion (search expression) that is input by the user. For such a demand for the document search, an approach using matching with a search criterion has been mainly utilized. In the approach, a document that (completely or partially) matches the search criterion input by the user is selected. The approach is utilized in many scenes.

In contrast, in such a matching technique, similar words having different notations but similar meanings, such as “deep machine learning” and “deep learning”, and equivalent words having the same meanings cannot be handled. For example, when a document including a word of either deep machine learning or deep learning is searched for, a search criterion of “(search for document including) deep machine learning or deep learning” is required to be input. “Deep machine learning”, however, has various similar words such as “deep neural network (DNN)” and “neural network” in addition to the above-described words. Therefore, it is practically difficult for, particularly, a non-expert to input a search criterion incorporating all such similar words.

In a search technique using the above-described representation vector, similar words can be efficiently searched for. The representation vector represents a meaning of a word, a document, and the like. The representation vector may be called a distributed representation vector, an embedding representation vector, etc.

Examples of a search approach using a search criterion including a representation vector and an AND operator include an approach in which the sum of representation vectors of a plurality of search words included in the search criterion is used as a representation vector of the search criterion. For example, documents are output as search results in descending ranking of values of the inner products of representation vectors of the search criterion and representation vectors of the document. The processing corresponds to calculating the sum of inner products of the representation vectors of search words and the representation vectors of the document.

Since sizes of representation vectors are different depending on words, values of inner products regarding the representation vectors with the document may be greatly different depending on the words. In such a case, a situation may occur such that the sum of representation vectors of a plurality of search words does not correctly reflect the search criterion. Moreover, it can be interpreted that, even if the sum of the representation vectors of the words corresponds to a search criterion including an AND operator, the sum of the representation vectors of the words does not correspond to a search criterion including another logical operator (OR operator, NOT operator, etc.). Therefore, a search approach in consideration of a logical operator other than an AND operator is demanded.

In the following embodiments, functions described below are provided to enable execution of a search uniformly using a search criterion including an AND operator, an OR operator, and a NOT operator by using a representation vector.
Function to calculate a degree of certainty expressed by a discrete value for each of words included in a search criterion, the degree of certainty representing certainty of correlation between each of the words and each document
Function to calculate, by using the degree of certainty, a score that is a continuous value obtained by converting a degree of similarity with each document for each word included in the search criterion
Function to calculate a conversion score by converting the score for each word included in the search criterion in accordance with a method corresponding to a logical operator (AND, OR, or NOT)
Function to calculate, by using the conversion score, a final degree of certainty that represents certainty of correlation between the search criterion and each document

Note that, hereinafter, a word is used as one or more phrases included in the search criterion. That is, an example in which a word is used as a unit of operand to which a logical operator is applied will be described. A phrase used as a unit is not limited to a word, and may include, for example, a plurality of words. A word included in the search criterion may be hereinafter referred to as a search word.

### First Embodiment

An example will be described in which an information processing apparatus of a first embodiment uses a plurality of pieces of document data as a plurality of pieces of information (target information) to be searched for. As described later, the target information is not limited to the document data.

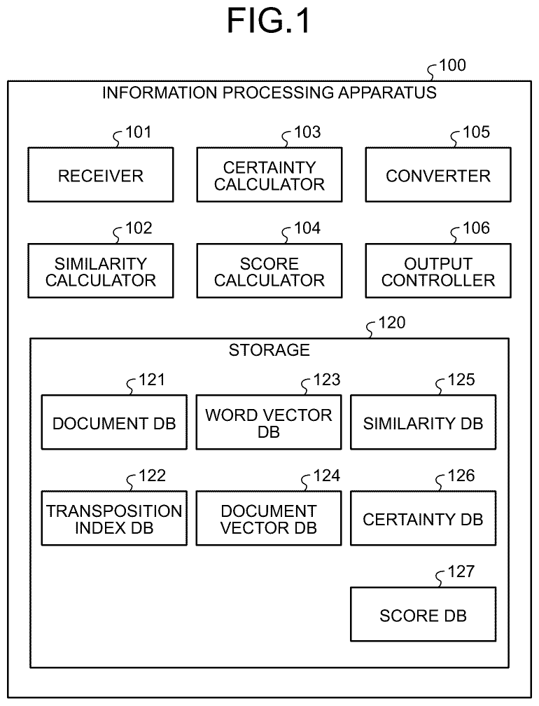

FIG. 1 is a block diagram illustrating one example of a configuration of an information processing apparatus 100 of the first embodiment. As illustrated in FIG. 1, the information processing apparatus 100 includes a receiver 101, a similarity calculator 102, a certainty calculator 103 (an example of a certainty calculator circuit), a score calculator 104 (an example of a score calculator circuit), a converter 105 (an example of a converter circuit), an output controller 106, and a storage 120.

The storage 120 stores various pieces of information used by the information processing apparatus 100. For example, the storage 120 stores a document database (DB) 121, a transposition index DB 122, a word vector DB 123, a document vector DB 124, a similarity DB 125, a certainty DB 126, and a score DB 127.

Note that the storage 120 can include all commonly used storage media such as a flash memory, a memory card, a random access memory (RAM), a hard disk drive (HDD), and an optical disk.

Part of or all the pieces of data (the document DB 121, the transposition index DB 122, the word vector DB 123, the document vector DB 124, the similarity DB 125, the certainty DB 126, and the score DB 127) stored in the storage 120 may be stored in physically different storage media, or may be stored in different storage areas of the physically same storage medium.

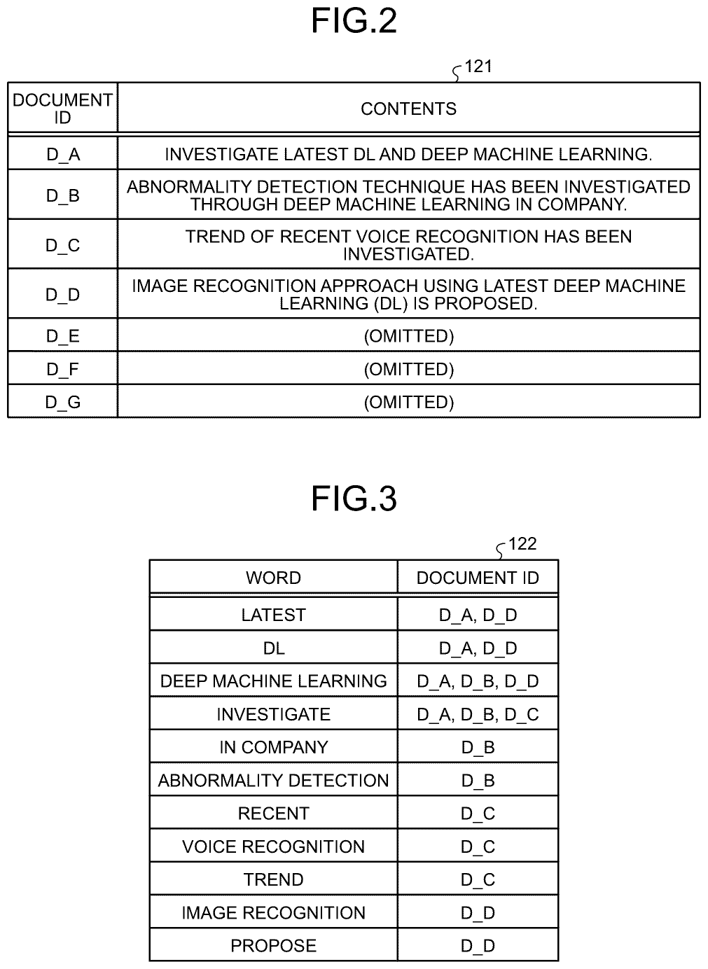

FIG. 2 illustrates one example of a data structure of the document DB 121. The document DB 121 stores document data to be searched for. As illustrated in FIG. 2, the document DB 121 includes document ID and contents. The document ID is identification information for identifying a document. The contents are data indicating the contents of the document.

Any kind of document may be stored in the document DB 121. The document stored in the document DB 121 includes, for example, the following documents. Japanese, English, and any other language may be used in the documents.
Presentation material
E-mail
Patent document
Report
Technical document
Blog
Document handled in social networking service (SNS)

All the documents as described above may be to be searched for, or a document selected from those documents may be to be searched for. It is assumed below that the document DB 121 stores documents (all documents or selected document) to be searched for. In other words, in the embodiment, all the documents stored in the document DB 121 are handled as being to be searched for.

Preprocessing may be preliminarily executed on document data. Any preprocessing may be executed. For example, processing as follows may be executed.
Leaving only words that appear at a frequency of the designated number of times or more
Removing insignificant words in the polite form
Recognizing, as a word, a partial string of the designated number of characters, called an N-gram
Extracting a word from a document by using a function of a tokenizer and the like.

Note that a result of preprocessing as described above is used when a transposition index is generated from document data, for example.

FIG. 3 illustrates one example of a data structure of the transposition index DB 122. The transposition index DB 122 is a database that stores a transposition index for identifying a document including a word. As illustrated in FIG. 3, the transposition index DB 122 includes word and document ID. The transposition index is used for identifying, for each word, a document including the word. FIG. 3 indicates that, for example, a word “deep machine learning” is included in documents with document IDs of “D_A”, “D_B”, and “D_D”.

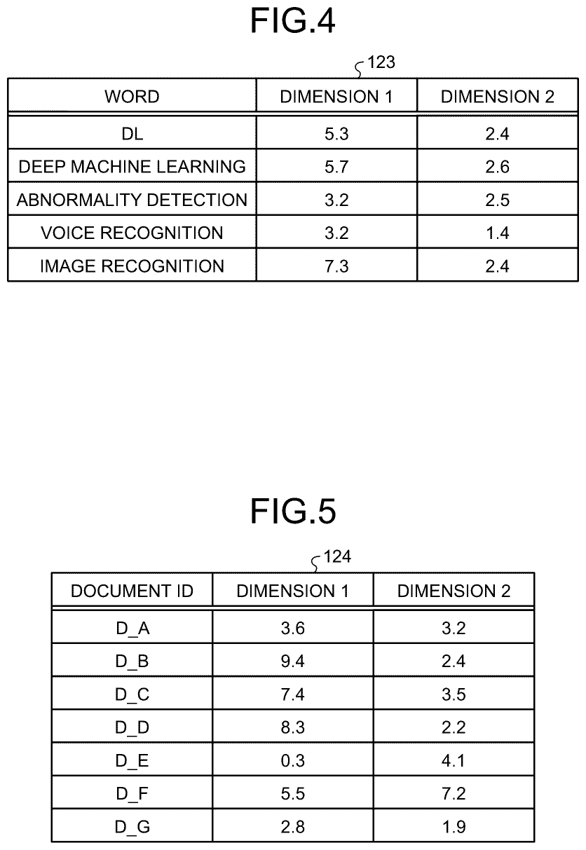

FIG. 4 illustrates one example of a data structure of the word vector DB 123. The word vector DB 123 stores a representation vector (hereinafter, also referred to as word vector) of each word. As illustrated in FIG. 4, the word vector DB 123 includes word and element values for each of dimensions (Dimension 1 and Dimension 2). Note that, although FIG. 4 (and FIG. 5 to be described later) illustrates an example of a two-dimensional representation vector, in general, a representation vector including a multidimensional element is used.

FIG. 5 illustrates one example of a data structure of the document vector DB 124. The document vector DB 124 stores a representation vector (hereinafter, also referred to as document vector) of each document. As illustrated in FIG. 5, the document vector DB 124 includes document ID and element values for each of the dimensions (Dimension 1 and Dimension 2).

The representation vector (word vector and document vector) may be calculated by any method. For example, an approach using techniques as follows can be applied.
Technique of a language model and natural language processing such as word2vec
Graph neural network technique

The document DB 121, the transposition index DB 122, the word vector DB 123, and the document vector DB 124 are preliminarily prepared and stored in the storage 120, for example. In contrast, the similarity DB 125, the certainty DB 126, and the score DB 127 correspond to databases for storing information output by processing of each unit of the information processing apparatus 100. Examples of data structures of the similarity DB 125, the certainty DB 126, and the score DB 127 will be described later.

The description returns to FIG. 1. The receiver 101 receives inputs of various pieces of information used in the information processing apparatus 100. For example, the receiver 101 receives a search criterion input by a user or the like. As described above, the search criterion can include a plurality of words and logical operators. For example, in a case of searching for a document correlated with both deep machine learning and abnormality detection but not correlated with both a natural language and image processing, a search criterion of “(deep machine learning AND abnormality detection) NOT (natural language OR image processing)” is input.

The similarity calculator 102 calculates a degree of similarity with each document for each search word. The degree of similarity may be calculated by any approach. The degree of similarity is calculated by, for example, a degree of cosine similarity between two representation vectors (word vector and document vector) or the inner product of two representation vectors. For example, the similarity calculator 102 calculates a degree of cosine similarity or the inner product between a word vector of a search word and a document vector of each document as the degree of similarity for each search word. For example, the similarity DB 125 stores the calculated degree of similarity.

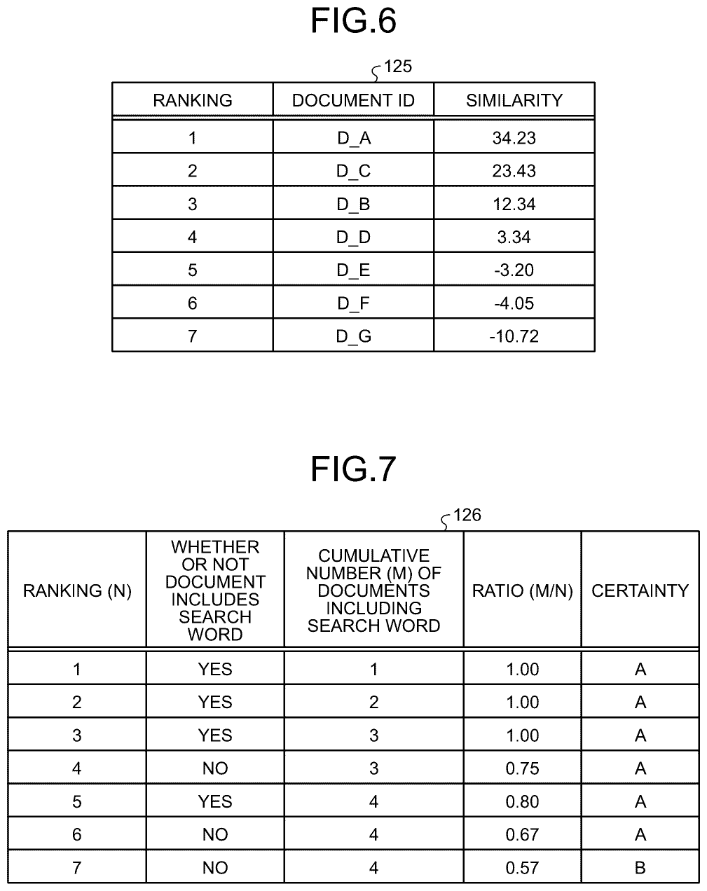

FIG. 6 illustrates one example of a data structure of the similarity DB 125. The similarity DB 125 stores a degree of similarity with each document for each word calculated by the similarity calculator 102. As illustrated in FIG. 6, the similarity DB 125 includes items of: a ranking (ranking), a document ID, and a degree of similarity. The ranking indicates a ranking at the time when documents are rearranged in accordance with the degree of similarity. Note that FIG. 6 illustrates an example of a degree of similarity between one word and all documents stored in the document DB 121. When the search criterion includes a plurality of search words, the degree of similarity is calculated for each of those search words, and stored in the similarity DB 125.

The description returns to FIG. 1. The certainty calculator 103 calculates, for each search word, a degree of certainty representing certainty of correlation between each of documents and the search word. The degree of certainty is expressed by a discrete value.

In one example, the certainty calculator 103 calculates a degree of certainty by using a ranking (ranking) based on the degree of similarity and determination information. The determination information is used for determining the correlation between a search word and a document. The determination information indicates, for example, whether or not each document includes the search word. In this case, the determination information can be determined by referring to the transposition index DB. For example, in a case where the search word is “latest”, the certainty calculator 103 can identify, from the transposition index DB 122 in FIG. 3, a document with a document ID of “D_A” or “D_D” as a document including “latest”. The certainty calculator 103 sets a value representing “Yes” in the determination information for a document including a search word, and sets a value representing “No” in the determination information for a document that does not include the search word.

Next, the certainty calculator 103 calculates, for each document, a degree of certainty by using a ratio (M/N) of a cumulative number (M) of documents whose determination information includes a search word, to a ranking (N) of the document. Note that the ratio (M/N) is one example of a value for calculating a degree of certainty. The degree of certainty may be calculated by using a value defined by factors other than the above-described factors expressed by M and N. The cumulative number of documents including a search word corresponds to, for example, the number of documents indicating that the determination information includes the search word among one or more documents of a ranking equal to or more than a ranking of a document for which the degree of certainty is calculated.

For example, the certainty calculator 103 calculates a degree of certainty expressed by a discrete value in accordance with a result of comparison between the ratio and one or more predetermined thresholds. For example, the certainty calculator 103 calculates a degree of certainty as follows by using two thresholds of 0.3 and 0.6.
In a case of a ratio of 0.6 or more and 1 or less: Certainty degree A
In a case of a ratio of 0.3 or more and less than 0.6: Certainty degree B
In a case of a ratio of 0 or more and less than 0.3: Certainty degree C.

In the above example, degrees of certainty with three values (three stages) are calculated by using two thresholds. The number of discrete values that can be taken by the thresholds and the degrees of certainty is not limited thereto. The certainty DB 126 stores the calculated degrees of certainty.

FIG. 7 illustrates one example of a data structure of the certainty DB 126. The certainty DB 126 stores a degree of certainty calculated by the certainty calculator 103. As illustrated in FIG. 7, the certainty calculator 103 includes items of: a ranking (N), information (determination information) indicating whether or not a document includes a search word, a cumulative number (M) of documents including the search word, a ratio (M/N), and a degree of certainty.

The description returns to FIG. 1. The score calculator 104 calculates a score that is a continuous value obtained by converting the degree of similarity between each document and a search word. In one example, the score calculator 104 calculates the score with each document for each search word by using a degree of similarity stored in the similarity DB 125 and a degree of certainty stored in the certainty DB 126.

More specifically, the score calculator 104 calculates, for each search word and each degree of certainty, the score by converting degrees of similarity such that the degrees of similarity fall within a range determined for the corresponding degree of certainty. In this case, the score calculator 104 calculates the score such that the score is a value maintaining the magnitude relation between degrees of similarity within the range.

In a case of Certainty degree A, a range of 0.67 or more and 1 or less is determined. The score calculator 104 calculates the score by converting the degrees of similarity of documents corresponding to Certainty degree A such that the degrees of similarity fall within the range. Any conversion method may be used. For example, a method using linear interpolation, nonlinear interpolation, spline interpolation, and a radial basis function can be used.

In the case of the range of Certainty degree A of 0.67 or more and 1 or less, for example, the range of Certainty degree B is 0.33 or more and less than 0.67, and the range of Certainty degree C. may be 0 or more and less than 0.33. This example can be interpreted as an example in which a score has a lower limit value 0 and an upper limit value 1 and degrees of certainty of three values are assigned to ranges obtained by roughly trisecting the range from the lower limit value to the upper limit value. The lower limit value and the upper limit value of the score are not limited to 0 and 1, respectively, and may be any other value. Moreover, a method of dividing the range between the lower limit value and the upper limit value into multiple ranges is not limited to the method of trisecting the range as described above.

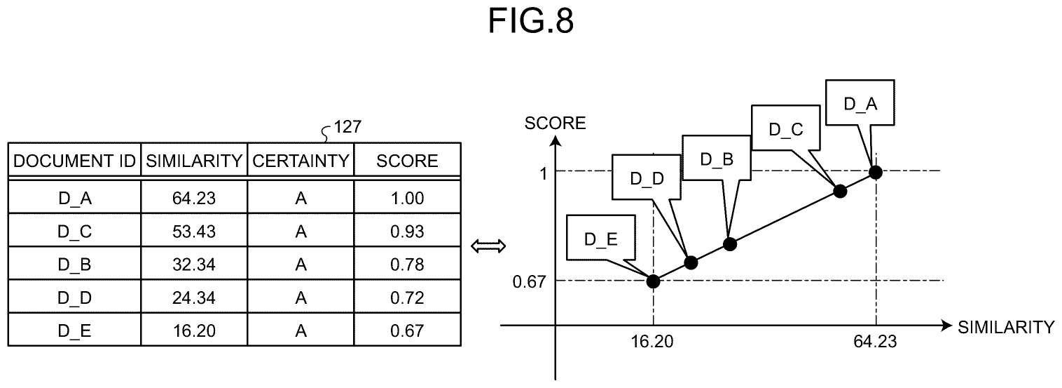

The calculated score is stored in the score DB 127. FIG. 8 illustrates one example of a data structure of the score DB 127. The score DB 127 stores a score calculated by the score calculator 104. Note that FIG. 8 also illustrates, on the right side of the figure, a graph indicating an example of an interpolation method when calculating the score.

As illustrated in FIG. 8, the score DB 127 includes items of: a document ID, a degree of similarity, a degree of certainty, and a score. Note that FIG. 8 illustrates an example of scores for a specific degree of certainty (Certainty degree A) of one search word. A score is calculated for each search word and each degree of certainty, and stored in the score DB 127.

In an example of FIG. 8, the degrees of similarity of five documents in Certainty degree A have values within the range of 16.20 to 64.23. The score calculator 104 calculates a score obtained by converting these values of the degree of similarity into values within the range of 0.67 or more and 1 or less determined for Certainty degree A. In the example of FIG. 8, the degree of similarity 16.20 is converted into a score 0.67, and the degree of similarity 64.23 is converted into a score 1.

The description returns to FIG. 1. The converter 105 converts a score calculated for each search word into a conversion score in accordance with a conversion method determined for a corresponding logical operator.

In a case where the logical operator is an AND operator, the converter 105 calculates a value that approximates to a smaller one of two scores calculated for two search words to which the AND operator is applied, as a conversion score for the two search words. In this case, the conversion score can be interpreted as a score obtained by integrating, into one, the two scores for the two search words to which the AND operator is applied.

The value approximating to the smaller one of the two scores is, for example, a value of the smaller one of the two scores (minimum value of score). The conversion score is not required to be a minimum value. The conversion score may be calculated in any manner as long as the conversion score is a value approximating to the smaller one of the two scores. For example, the conversion score may be a value corresponding to the first quartile of the two scores.

In a case where the logical operator is an OR operator, the converter 105 calculates a value that approximates to a larger one of two scores calculated for two search words to which the OR operator is applied as a conversion score for the two search words. In this case, the conversion score can be interpreted as a score obtained by integrating, into one, the two scores for the two search words to which the OR operator is applied.

The value approximating to the larger one of the two scores is, for example, a value of the larger one of the two scores (maximum value of score). The conversion score is not required to be a maximum value. The conversion score may be calculated in any manner as long as the conversion score is a value approximating to the larger one of the two scores. For example, the conversion score may be a value corresponding to the third quartile of the two scores.

In a case where the logical operator is a NOT operator, the converter 105 calculates a conversion score of a search word such that the larger a value of a score calculated for one search word to which the NOT operator is applied is, the smaller a value of a score to be calculated for the one search word (and vice versa). In one example, the converter 105 calculates, as a conversion score, a value obtained by subtracting a score from the upper limit value (e.g., 1) of the score.

The converter 105 may calculate the final degree of certainty for each document by using the conversion score. In one example, the converter 105 calculates the final degree of certainty with reference to a range of value that is determined for each degree of certainty and used at the time when the score calculator 104 calculates a score.

As in the above-described example, the range of Certainty degree A is 0.67 or more and 1 or less. The range of Certainty degree B is 0.33 or more and less than 0.67. The range of Certainty degree C. is 0 or more and less than 0.33. In this case, when a conversion score is 0.7, the converter 105 calculates Certainty degree A, which corresponds to a range including 0.7, as the final degree of certainty.

The search criterion may include a plurality of logical operators. In such a case, the converter 105 repeats processing (score conversion processing) of converting an operand (score or conversion score) into a conversion score in accordance with an order (priority order) of applying the individual logical operators.

In one example, when the above-described search criterion of “(deep machine learning AND abnormality detection) NOT (natural language OR image processing)” is input, the score conversion processing may be executed in an order described below.
(A1) Calculate a conversion score by using a score of a search word “deep machine learning” and a score of a search word “abnormality detection” for an AND operator
(A2) Calculate a conversion score by using a score of a search word “natural language” and a score of a search word “image processing” for an OR operator
(A3) calculate a conversion score obtained by further converting the conversion score calculated in (A2) for a NOT operator
(A4) calculate a conversion score obtained by conversion in accordance with the AND operator for the conversion score calculated in (A1) and the conversion score calculated in (A3)

The output controller 106 controls output of various pieces of information used by the information processing apparatus 100. In one example, the output controller 106 outputs one or more documents selected in accordance with a conversion score as a search result. The output controller 106 may output the final degree of certainty for each document determined based on the conversion score.

Any method can be used as a method of the output controller 106 outputting information. In one example, a method of displaying information on a display device such as a display and a method of transmitting information to another device (e.g., server device) via a network can be used.

One or more processing units may implement at least part of the above-described units (the receiver 101, the similarity calculator 102, the certainty calculator 103, the score calculator 104, the converter 105, and the output controller 106). One or more hardware processors implement the above-described units. In one example, each of the above-described units may be implemented by causing a hardware processor such as a central processing unit (CPU) and a graphics processing unit (GPU) to execute a computer program, namely, implemented by software. Each of the above-described units may be implemented by a hardware processor such as a dedicated integrated circuit (IC), namely, implemented by hardware. Each of the above-described units may be implemented by using software and hardware together. When multiple processors are used, each processor may implement one of the units, or may implement two or more of the units.

The information processing apparatus 100 may physically include one device, or may physically include a plurality of devices. For example, the information processing apparatus 100 may be constructed in a cloud environment. The units in the information processing apparatus 100 may be dispersed in two or more devices.

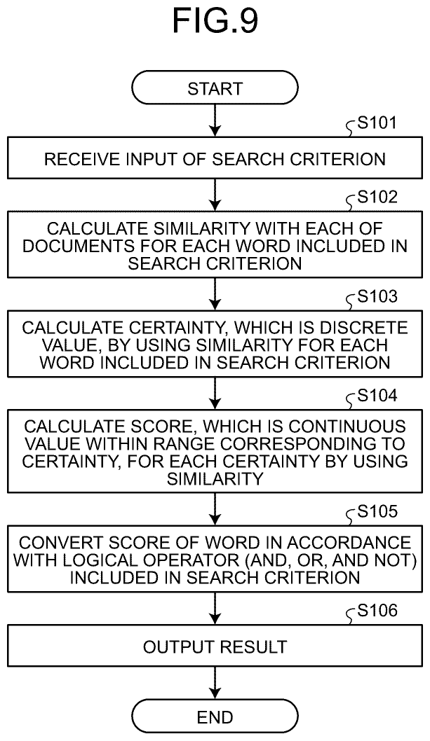

Next, search processing performed by the information processing apparatus 100 of the first embodiment will be described. FIG. 9 is a flowchart illustrating one example of the search processing in the first embodiment.

The receiver 101 receives a search criterion input by a user or the like (Step S101). The similarity calculator 102 calculates a degree of similarity with each of documents stored in the document DB 121 for each word (search word) included in the search criterion (Step S102).

The certainty calculator 103 calculates a degree of certainty, which is a discrete value, by using the degree of similarity for each search word included in the search criterion (Step S103). The score calculator 104 calculates a score that is a continuous value within a range corresponding to the degree of certainty, for each search word and for each degree of certainty, by using the degree of similarity (Step S104).

The converter 105 calculates a conversion score obtained by converting a score of a word in accordance with a logical operator (AND, OR, or NOT) included in the search criterion (Step S105). The output controller 106 outputs a conversion score, which is a processing result (Step S106), and ends the search processing. The output controller 106 may output the final degree of certainty for each document determined by using the conversion score as a processing result.

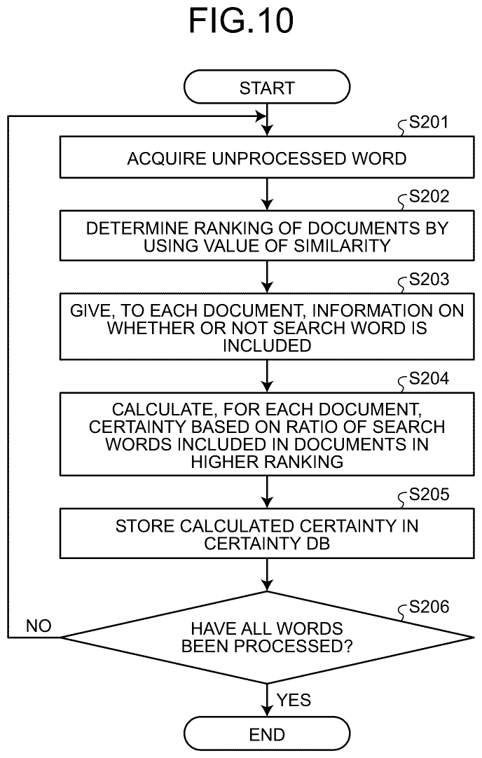

Next, details of processing to calculate a degree of certainty in Step S103 will be described. FIG. 10 is a flowchart illustrating one example of the certainty degree calculation processing.

The certainty calculator 103 acquires an unprocessed word out of words (search words) included in the search criterion (Step S201). The certainty calculator 103 determines the ranking of documents by using a value of the degree of similarity calculated by the similarity calculator 102 (Step S202). The certainty calculator 103 gives, to each document, information (determination information) on whether or not the search word is included (Step S203). In one example, the certainty calculator 103 gives determination information in which a value of “Yes” is set in a case where the document includes the search word and a value of “No” is set otherwise.

The certainty calculator 103 calculates, for each document, a degree of certainty based on a value defined by the factors M and N, such as a ratio (M/N) of search words included in the document and documents in the higher ranking than the document (Step S204). The certainty calculator 103 stores the calculated degree of certainty in the certainty DB 126 (Step S205).

The certainty calculator 103 determines whether or not all search words have been processed (Step S206). When not all the search words have been processed (Step S206: No), the certainty calculator 103 returns to Step S201, and repeats the processing for the next unprocessed search word. When all the search words have been processed (Step S206: Yes), the certainty calculator 103 ends the certainty degree calculation processing.

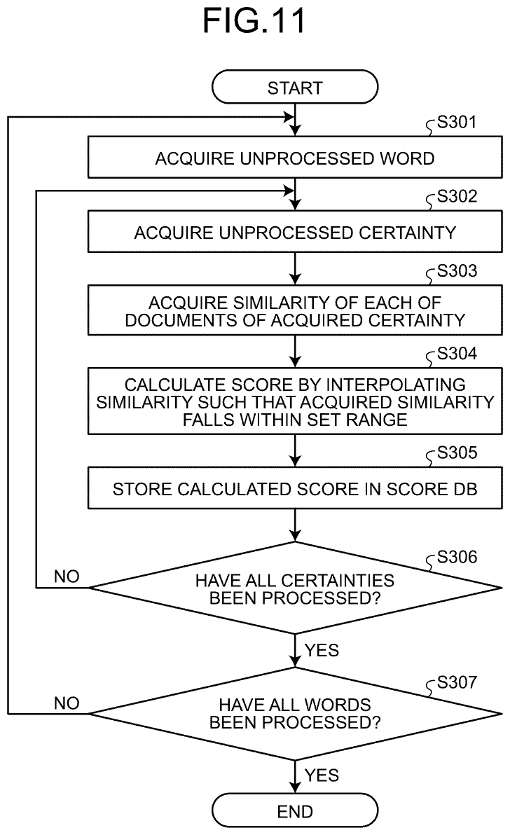

Next, details of the score calculation processing in Step S104 will be described. FIG. 11 is a flowchart illustrating one example of the score calculation processing.

The score calculator 104 acquires an unprocessed word among the words (search words) included in the search criterion (Step S301). The score calculator 104 acquires an unprocessed degree of certainty for the acquired search word (Step S302).

The score calculator 104 acquires a degree of similarity of each document of the acquired degree of certainty from the similarity DB 125 (Step S303). The score calculator 104 calculates a score by interpolating the degree of similarity such that the acquired degree of similarity falls within a set range (Step S304). The score calculator 104 stores the calculated score in the score DB 127 (Step S305).

The score calculator 104 determines whether or not all the degrees of certainty have been processed (Step S306). When not all the degrees of certainty have been processed (Step S306: No), the score calculator 104 returns to Step S302, and repeats the processing on the next unprocessed degree of certainty.

When all the degrees of certainty have been processed (Step S306: Yes), the score calculator 104 determines whether or not all the search words have been processed (Step S307). When not all the search words have been processed (Step S307: No), the score calculator 104 returns to Step S301, and repeats the processing for the next unprocessed search word. When all the search words have been processed (Step S307: Yes), the score calculator 104 ends the score calculation processing.

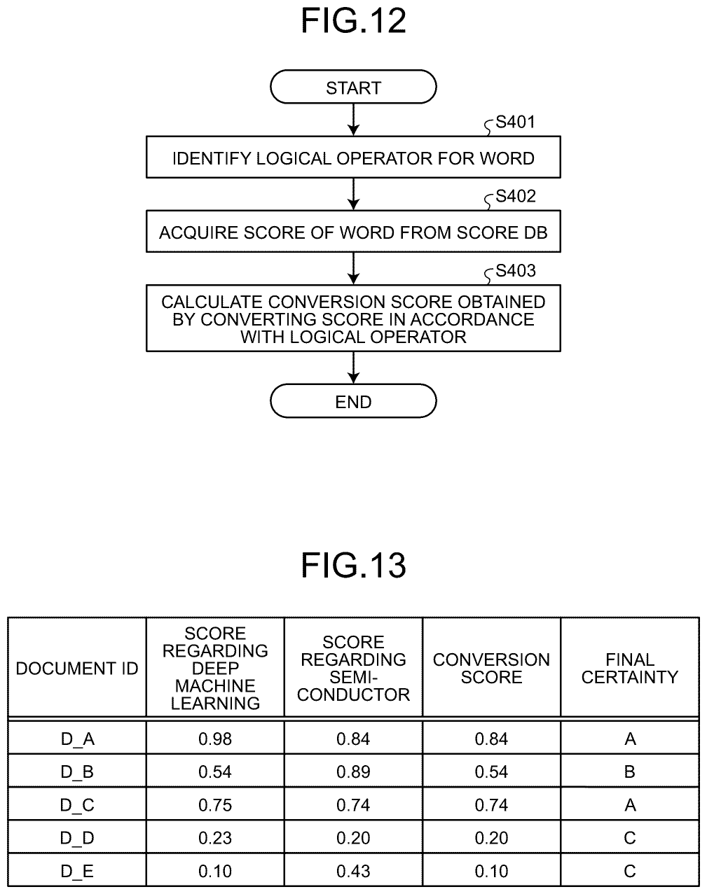

Next, details of the score conversion processing in Step S105 will be described. FIG. 12 is a flowchart illustrating one example of the score conversion processing.

The converter 105 identifies a logical operator for a word (search word) included in the search criterion (Step S401). The converter 105 acquires a score of the search word from the score DB 127 (Step S402). The converter 105 calculates a conversion score obtained by converting the score by a conversion method in accordance with the logical operator (Step S403).

FIGS. 13 to 15 illustrate examples of conversion scores. FIGS. 13, 14, and 15 illustrate examples of conversion scores under search criteria including an AND operator, an OR operator, and a NOT operator, respectively.

In FIG. 13, examples of a conversion score for a search criterion of “deep machine learning AND semiconductor” are illustrated. For a document with a document ID of “D_A”, a score for “deep machine learning” is 0.98, and a score for “semiconductor” is 0.84. Assuming that a conversion method for setting a value of a smaller one of two scores as a conversion score is determined for the AND operator, 0.84 is obtained as the conversion score.

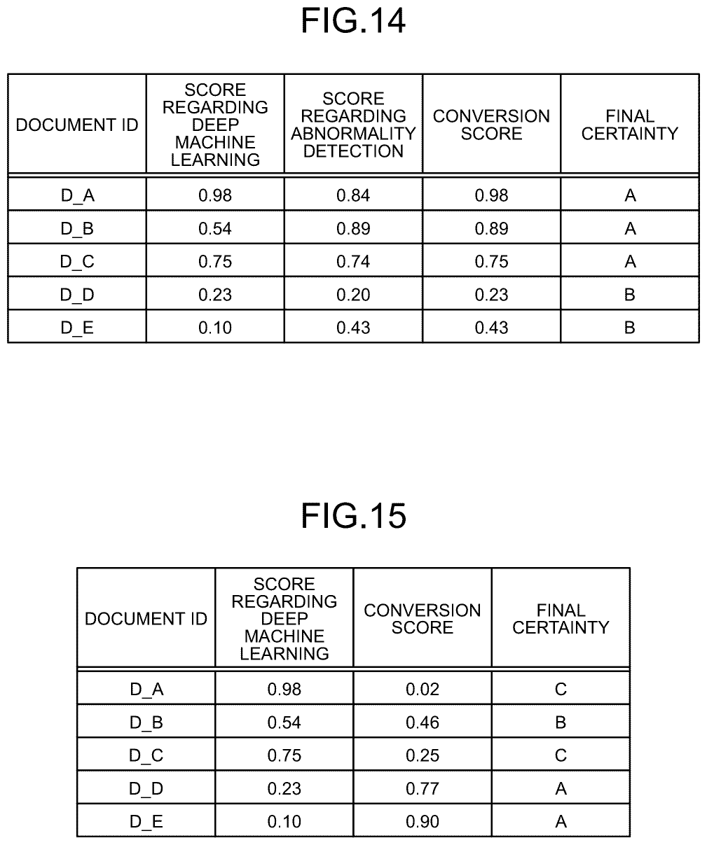

In FIG. 14, examples of a conversion score for a search criterion of “deep machine learning OR abnormality detection” are illustrated. For a document with a document ID of “D_A”, a score for “deep machine learning” is 0.98, and a score for “abnormality detection” is 0.84. Assuming that a conversion method for setting a value of a larger one of two scores as a conversion score is determined for the OR operator, 0.98 is obtained as the conversion score.

In FIG. 15, examples of a conversion score for a search criterion of “NOT deep machine learning” are illustrated. For the document with a document ID of “D_A”, a score for “deep machine learning” is 0.98. Assuming that a conversion method of calculating a value obtained by subtracting a score from the upper limit value 1 of the score as a conversion score is determined for the NOT operator, 0.02 is obtained as the conversion score.

Note that FIGS. 13 to 15 also illustrate the final degrees of certainty calculated by using a conversion score.

As described above, in the information processing apparatus of the first embodiment, it is possible to uniformly execute search using search criteria including the AND operator, the OR operator, and the NOT operator using a representation vector for document data.

### Second Embodiment

In the above-described first embodiment, information representing whether or not each document includes a search word is used as the determination information. An information processing apparatus according to a second embodiment uses determination information different from that of the first embodiment.

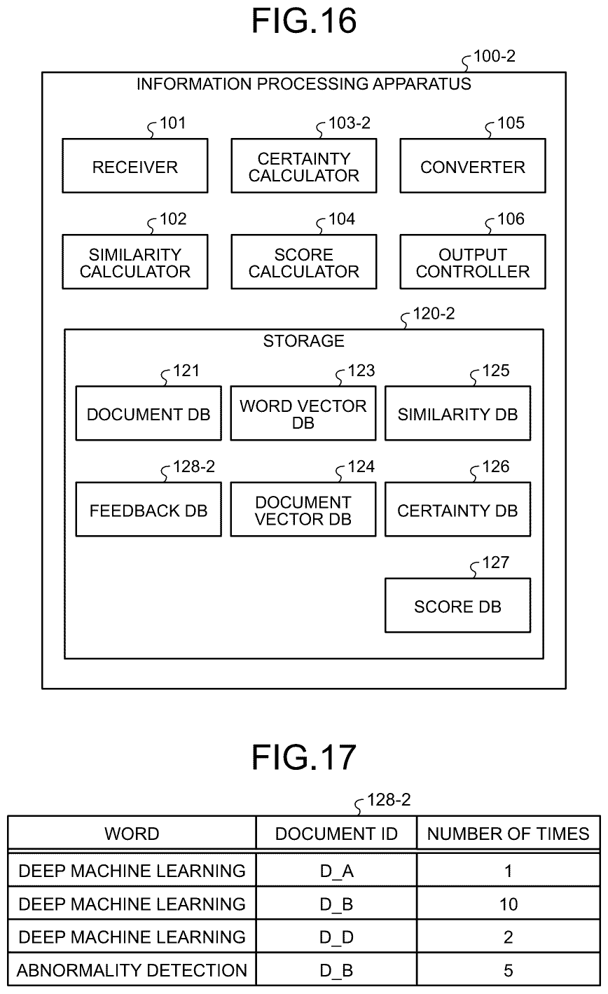

FIG. 16 is a block diagram illustrating one example of a configuration of an information processing apparatus 100-2 of the second embodiment. As illustrated in FIG. 16, the information processing apparatus 100-2 includes a receiver 101, a similarity calculator 102, a certainty calculator 103-2, a score calculator 104, a converter 105, an output controller 106, and a storage 120-2.

The second embodiment is different from the first embodiment in a function of the certainty calculator 103-2 and a point that the storage 120-2 includes a feedback DB 128-2 instead of the transposition index DB 122. Other configurations and functions are similar to those in FIG. 1, which is a block diagram of the information processing apparatus 100 of the first embodiment, and are thus denoted by the same reference signs to omit description thereof here.

The feedback DB 128-2 stores, for each search word, the number of times each document searched for by the search word is selected by, for example, a user as feedback information. FIG. 17 illustrates one example of a data structure of the feedback DB 128-2. As illustrated in FIG. 17, the feedback DB 128-2 includes word, document ID, and number of times. The number of times represents the number of times a document (document identified by document ID) searched for under a search criterion including a corresponding word is selected by the user.

It can be interpreted that, the larger the number of times, the higher the correlation between a corresponding search word and a corresponding document becomes. Therefore, in the embodiment, the correlation between a search word and a document is determined by using such feedback information as determination information.

The certainty calculator 103-2 calculates a degree of certainty by using a ranking based on a degree of similarity and determination information representing whether or not the document has been selected as information correlating with a search word.

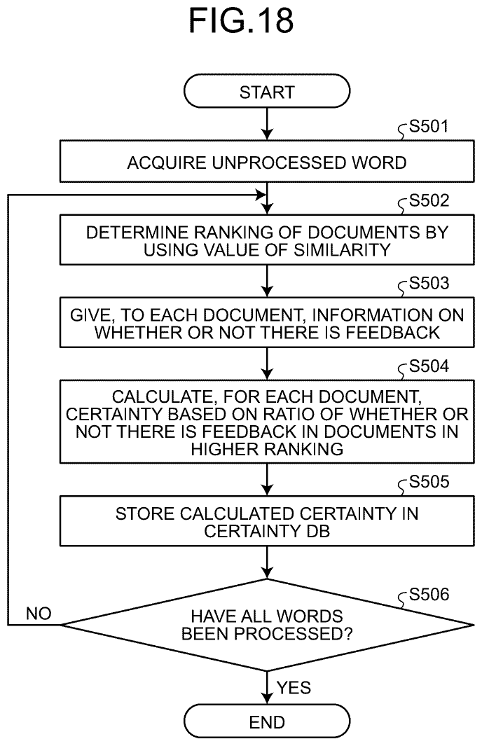

Next, details of certainty degree calculation processing in the embodiment will be described. FIG. 18 is a flowchart illustrating one example of the certainty degree calculation processing.

In Steps S501 and S502, processing similar to that in Steps S201 and S202 in the certainty degree calculation processing (FIG. 10) of the first embodiment is performed, so that description thereof will be omitted.

The certainty calculator 103-2 gives, to each document, information (determination information) on whether or not the number of times of feedback is equal to or greater than a specified number of times (Step S503). In one example, the certainty calculator 103-2 gives determination information in which a value representing “Yes” is set when the number of times corresponding to the document is equal to or greater than a specified number of times, and a value representing “No” is set otherwise.

In Steps S504 to S506, processing similar to that in Steps S204 to S206 in the certainty degree calculation processing (FIG. 10) of the first embodiment is performed, so that description thereof will be omitted.

### Third Embodiment

A complex search criterion can be designated by combining logical operators (AND, NOT, and OR) with symbols such as brackets indicating an order (priority order) of applying the individual operators. In contrast, imposing an excessively complex search criterion on the user may lead to a decrease in satisfaction. Therefore, an information processing apparatus of a third embodiment has a function of more easily inputting a search criterion including a logical operator.

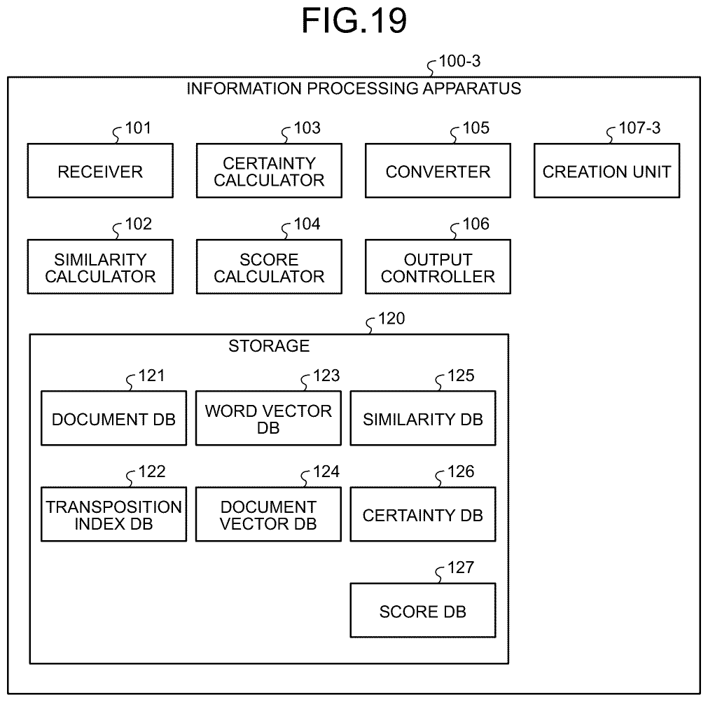

FIG. 19 is a block diagram illustrating one example of a configuration of an information processing apparatus 100-3 of a third embodiment. As illustrated in FIG. 19, the information processing apparatus 100-3 includes a receiver 101, a similarity calculator 102, a certainty calculator 103, a score calculator 104, a converter 105, an output controller 106, a creation unit 107-3, and a storage 120.

The third embodiment is different from the first embodiment in that the creation unit 107-3 is added. Other configurations and functions are similar to those in FIG. 1, which is a block diagram of the information processing apparatus 100 of the first embodiment, and are thus denoted by the same reference signs to omit description thereof here.

The creation unit 107-3 creates a search criterion from one or more words input through an input screen. The input screen includes a region RA (first region) and a region RB (second region). In the region RA, one or more words WA (first phrases) are designated. The one or more words WA are designated as words included in a document (target information) serving as a search result. In the region RB, one or more words WB (second phrases) are designated. The one or more words WB are designated as words not included in the document serving as a search result.

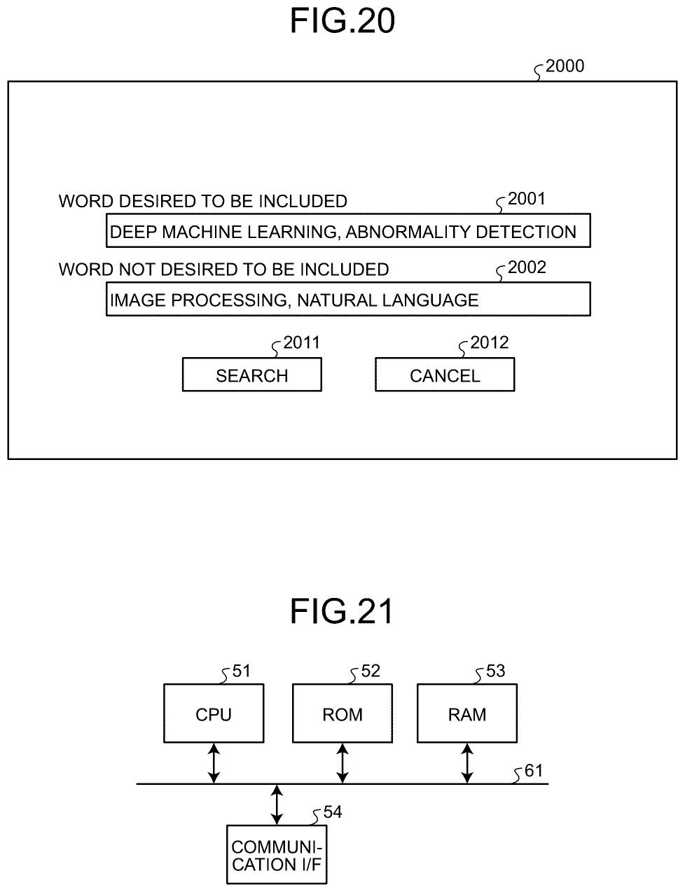

FIG. 20 illustrates one example of an input screen 2000. The input screen 2000 includes a region 2001, a region 2002, a search button 2011, and a cancel button 2012. The region 2001 corresponds to the region RA. The region 2002 corresponds to the region RB.

When the cancel button 2012 is pressed, the output controller 106 displays a screen that had been displayed until the input screen was displayed. When the search button 2011 is pressed, for example, the receiver 101 receives one or more words WA input to the region 2001 and one or more words WB input to the region 2002, and gives the one or more words WA and the one or more words WB to the creation unit 107-3.

The creation unit 107-3 creates a search criterion using AND, OR, and NOT operators by using the given information. When a plurality of words WA is input to the region 2001, the creation unit 107-3 creates a search criterion in which the input words WA are connected by an AND operator. When a plurality of words WB is input to the region 2002, the creation unit 107-3 creates a search criterion in which the input words WB are connected by an OR operator and a NOT operator is added. When search words are input to the regions 2001 and 2002, the creation unit 107-3 creates a search criterion by connecting search criteria created for both the regions.

Specifically, as illustrated in FIG. 20, when the words WA (word desired to be included) are “deep machine learning, abnormality detection” and the words WB (word not desired to be included) are “image processing, natural language”, the creation unit 107-3 creates a search criterion “(deep machine learning AND semiconductor) NOT (voice OR device)”.

The search processing using a created search criterion is similar to that in the first embodiment, so that description thereof will be omitted. Note that the creation unit 107-3 may be added to the second embodiment.

As described above, in the information processing apparatus of the third embodiment, a search criterion can be more easily input.

### Variation 1

In Variation 1, a threshold to be used at the time when a degree of certainty is calculated can be adjusted. For example, the certainty calculator 103 of the variation adjusts (changes) a threshold for calculating degree of certainty in accordance with feedback information such as a situation of document selection performed by a user.

For example, the threshold may be adjusted such that the number of documents corresponding to degrees of certainty is not biased. In the example of FIG. 7, the value of the threshold defining Certainty degree A is changed from 0.6 to 0.8. This causes the number of documents for which Certainty degree A is calculated to be four, and the number of documents for which Certainty degree B is calculated to be three.

The certainty calculator 103 of the variation may set an average value of thresholds adjusted for a plurality of search words as a final threshold.

### Variation 2

As described above, information (target information) to be searched for is not limited to document data. Information other than the document data may be set as target information as long as the information can be represented by a representation vector. An example of the target information other than document data will be described below.

For example, image data and information representing a product (hereinafter, product data) can be used as the target information. A method using a graph neural network and deep learning can be applied as a method of determining a representation vector for the image data and the product data.

In a case of the image data, for example, it is intended to search for image data including an object described in a search criterion or image data not including the object. Therefore, the certainty calculator 103 can use determination information representing whether or not image data includes an object described in a search criterion.

In a case of product data, for example, it is intended to search for product data that matches a search criterion designated by a product category, an attribute of a product (e.g., lemon flavor), and the like. Therefore, the certainty calculator 103 can use determination information representing whether or not product data satisfies the designated search criterion.

As described above, according to the first to third embodiments, information can be more appropriately searched for.

Next, hardware configurations of the information processing apparatuses of the first to third embodiments will be described with reference to FIG. 21. FIG. 21 is an explanatory diagram illustrating an example of the hardware configurations of the information processing apparatuses of the first to third embodiments.

The information processing apparatuses of the first to third embodiments include a control device, a storage device, a communication I/F 54, and a bus 61. The control device includes a central processing unit (CPU) 51. The storage device includes a read only memory (ROM) 52 and a random access memory (RAM) 53. The communication I/F 54 is connected to a network to perform communication. The bus 61 connects the units.

A computer program to be executed by the information processing apparatuses of the first to third embodiments is provided by being preliminarily incorporated in the ROM 52 or the like.

The computer program to be executed by the information processing apparatuses of the first to third embodiments may be provided as a computer program product by being recorded in a computer-readable recording medium, such as a compact disk read only memory (CD-ROM), a flexible disk (FD), a compact disk recordable (CD-R), and a digital versatile disk (DVD), in a file in an installable or executable format.

Moreover, the computer program to be executed by the information processing apparatuses of the first to third embodiments may be provided by being stored on a computer connected to a network such as the Internet and downloaded via the network. The computer program to be executed by the information processing apparatuses of the first to third embodiments may be provided or distributed via the network such as the Internet.

The computer program to be executed by the information processing apparatuses of the first to third embodiments can cause a computer to function as each unit of the information processing apparatuses described above. In the computer, the CPU 51 can read a computer program from a computer-readable storage medium onto a main storage device, and execute the computer program.

Configuration examples of the embodiments will be described below.

### Configuration Example 1

An information processing apparatus comprising
one or more hardware processors connected to a memory and configured to:
   calculate a degree of certainty expressed by a discrete value for each of one or more phrases included in a search criterion, the search criterion including the one or more phrases and one or more logical operators, the degree of certainty representing certainty of correlation between each of pieces of target information to be searched for and the one or more phrases;
   calculate a score for each of the one or more phrases, the score being a continuous value obtained by converting degrees of similarity between the pieces of target information and the one or more phrases, the score being calculated such that the degrees of similarity fall within a range determined for the degree of certainty; and
   convert the score calculated for each of the one or more phrases into a conversion score in accordance with a conversion method determined for each of the one or more logical operators.

### Configuration Example 2

The information processing apparatus according to the configuration example 1, wherein the one or more hardware processors are configured to perform the calculation of the degree of certainty by using, for each of the pieces of target information, a ranking based on the degrees of similarity and determination information representing whether the pieces of target information include the one or more phrases.

### Configuration Example 3

The information processing apparatus according to the configuration example 2, wherein the one or more hardware processors are configured to perform the calculation of the degree of certainty by using a ratio of a factor M to a factor N, the factor N being a ranking of target information for which the degree of certainty is to be calculated, the factor M being a number of pieces of target information representing that the determination information includes the one or more phrases out of target information whose ranking is equal to or higher than the ranking of the target information for which the degree of certainty is to be calculated.

### Configuration Example 4

The information processing apparatus according to the configuration example 1, wherein the one or more hardware processors are configured to perform the calculation of the degree of certainty by using: a ranking based on the degrees of similarity, and determination information representing whether the target information has been selected as information correlating with the one or more phrases.

### Configuration Example 5

The information processing apparatus according to any one of the configuration examples 1 to 4, wherein the one or more hardware processors are configured to calculate, as the score, a value maintaining a magnitude relation between the degrees of similarity within the range.

### Configuration Example 6

The information processing apparatus according to the configuration example 5, wherein the one or more hardware processors are configured to calculate the score by converting the degrees of similarity by linear interpolation or nonlinear interpolation.

### Configuration Example 7

The information processing apparatus according to any one of the configuration examples 1 to 6, wherein
the one or more logical operators include an AND operator, and
the one or more hardware processors are configured to calculate a value as the conversion score for two phrases to which the AND operator is applied, the value approximating to a smaller one of two scores calculated for the two phrases.

### Configuration Example 8

The information processing apparatus according to the configuration example 7, wherein the one or more hardware processors are configured to calculate the value as the conversion score for two phrases to which the AND operator is applied, the value being equal to a smaller one of two scores calculated for the two phrases.

### Configuration Example 9

The information processing apparatus according to any one of the configuration examples 1 to 8, wherein
the one or more logical operators include an OR operator, and
the one or more hardware processors are configured to calculate a value as the conversion score for two phrases to which the OR operator is applied, the value approximating to a larger one of two scores calculated for the two phrases.

### Configuration Example 10

The information processing apparatus according to the configuration example 9, wherein the one or more hardware processors are configured to calculate the value as the conversion score for two phrases to which the OR operator is applied, the value being equal to a larger one of two scores calculated for the two phrases.

### Configuration Example 11

The information processing apparatus according to any one of the configuration examples 1 to 10, wherein
the one or more logical operators include a NOT operator, and
the one or more hardware processors are configured to perform the calculation of the conversion score such that the larger a value of a score calculated for the one or more phrases to which the NOT operator is applied is, the smaller a value of the conversion score to be calculated becomes.

### Configuration Example 12

The information processing apparatus according to the configuration example 1, wherein the one or more hardware processors are further configured to output one or more pieces of target information selected in accordance with the conversion score.

### Configuration Example 13

The information processing apparatus according to the configuration example 12, wherein the one or more hardware processors are further configured to output outputs the degree of certainty determined based on the conversion score.

### Configuration Example 14

The information processing apparatus according to any one of the configuration examples 1 to 13, wherein the one or more hardware processors are further configured to create the search criterion based on one or more first phrases and one or more second phrases, the first phrases being included in target information obtained as a search result, the second phrases being outside the target information, the first phrases and the second phrases being input through an input screen including a first region for designating the first phrases and a second region for designating the second phrases.

### Configuration Example 15

The information processing apparatus according to any one of the configuration examples 1 to 14, wherein the one or more hardware processors are further configured, when the search criterion includes logical operators, to repeat processing of the conversion of the score into the conversion score in accordance with an order of applying the logical operators.

### Configuration Example 16

The information processing apparatus according to any one of the configuration examples 1 to 15, wherein the target information is at least one of document data and image data.

### Configuration Example 17

The information processing apparatus according to any one of the configuration examples 1 to 16, wherein the one or more hardware processors include
a certainty calculator circuit configured to calculate the degree of certainty,
a score calculator circuit configured to calculate the score, and
a converter circuit configured to output the conversion score.

### Configuration Example 18

An information processing method to be implemented by a computer, the method comprising:
calculating a degree of certainty expressed by a discrete value for each of one or more phrases included in a search criterion, the search criterion including the one or more phrases and one or more logical operators, the degree of certainty representing certainty of correlation between each of pieces of target information to be searched for and the one or more phrases;
calculating a score for each of the one or more phrases, the score being a continuous value obtained by converting degrees of similarity between the pieces of target information and the one or more phrases, the score being calculated such that the degrees of similarity fall within a range determined for the degree of certainty; and
converting the score calculated for each of the one or more phrases into a conversion score in accordance with a conversion method determined for each of the one or more logical operators.

### Configuration Example 19

A computer program product comprising a non-transitory computer-readable recording medium on which a computer program is recorded, the program instructing the computer to:
calculate a degree of certainty expressed by a discrete value for each of one or more phrases included in a search criterion, the search criterion including the one or more phrases and one or more logical operators, the degree of certainty representing certainty of correlation between each of pieces of target information to be searched for and the one or more phrases;
calculate a score for each of the one or more phrases, the score being a continuous value obtained by converting degrees of similarity between the pieces of target information and the one or more phrases, the score being calculated such that the degrees of similarity fall within a range determined for the degree of certainty; and
convert the score calculated for each of the one or more phrases into a conversion score in accordance with a conversion method determined for each of the one or more logical operators.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising
one or more hardware processors configured to:
calculate a degree of certainty expressed by a discrete value for each of one or more phrases included in a search criterion, the search criterion including the one or more phrases and one or more logical operators, the degree of certainty representing certainty of correlation between each of pieces of target information to be searched for and the one or more phrases;
calculate a score for each of the one or more phrases, the score being a continuous value obtained by converting degrees of similarity between the pieces of target information and the one or more phrases, the score being calculated such that the degrees of similarity fall within a range determined for the degree of certainty; and
convert the score calculated for each of the one or more phrases into a conversion score in accordance with a conversion method determined for each of the one or more logical operators.

2. The information processing apparatus according to claim 1, wherein the one or more hardware processors are configured to perform the calculation of the degree of certainty by using, for each of the pieces of target information, a ranking based on the degrees of similarity and determination information representing whether the pieces of target information include the one or more phrases.

3. The information processing apparatus according to claim 2, wherein the one or more hardware processors are configured to perform the calculation of the degree of certainty by using a ratio of a factor M to a factor N, the factor N being a ranking of target information for which the degree of certainty is to be calculated, the factor M being a number of pieces of target information representing that the determination information includes the one or more phrases out of target information whose ranking is equal to or higher than the ranking of the target information for which the degree of certainty is to be calculated.

4. The information processing apparatus according to claim 1, wherein the one or more hardware processors are configured to perform the calculation of the degree of certainty by using: a ranking based on the degrees of similarity, and determination information representing whether the target information has been selected as information correlating with the one or more phrases.

5. The information processing apparatus according to claim 1, wherein the one or more hardware processors are configured to calculate, as the score, a value maintaining a magnitude relation between the degrees of similarity within the range.

6. The information processing apparatus according to claim 5, wherein the one or more hardware processors are configured to calculate the score by converting the degrees of similarity by linear interpolation or nonlinear interpolation.

7. The information processing apparatus according to claim 1, wherein
the one or more logical operators include an AND operator, and
the one or more hardware processors are configured to calculate a value as the conversion score for two phrases to which the AND operator is applied, the value approximating to a smaller one of two scores calculated for the two phrases.

8. The information processing apparatus according to claim 7, wherein the one or more hardware processors are configured to calculate the value as the conversion score for two phrases to which the AND operator is applied, the value being equal to a smaller one of two scores calculated for the two phrases.

9. The information processing apparatus according to claim 1, wherein
the one or more logical operators include an OR operator, and
the one or more hardware processors are configured to calculate a value as the conversion score for two phrases to which the OR operator is applied, the value approximating to a larger one of two scores calculated for the two phrases.

10. The information processing apparatus according to claim 9, wherein the one or more hardware processors are configured to calculate the value as the conversion score for two phrases to which the OR operator is applied, the value being equal to a larger one of two scores calculated for the two phrases.

11. The information processing apparatus according to claim 1, wherein
the one or more logical operators include a NOT operator, and
the one or more hardware processors are configured to perform the calculation of the conversion score such that the larger a value of a score calculated for the one or more phrases to which the NOT operator is applied is, the smaller a value of the conversion score to be calculated becomes.

12. The information processing apparatus according to claim 1, wherein the one or more hardware processors are further configured to output one or more pieces of target information selected in accordance with the conversion score.

13. The information processing apparatus according to claim 12, wherein the one or more hardware processors are further configured to output outputs the degree of certainty determined based on the conversion score.

14. The information processing apparatus according to claim 1, wherein the one or more hardware processors are further configured to create the search criterion based on one or more first phrases and one or more second phrases, the first phrases being included in target information obtained as a search result, the second phrases being outside the target information, the first phrases and the second phrases being input through an input screen including a first region for designating the first phrases and a second region for designating the second phrases.

15. The information processing apparatus according to claim 1, wherein the one or more hardware processors are further configured, when the search criterion includes logical operators, to repeat processing of the conversion of the score into the conversion score in accordance with an order of applying the logical operators.

16. The information processing apparatus according to claim 1, wherein the target information is at least one of document data and image data.

17. The information processing apparatus according to claim 1, wherein the one or more hardware processors include
a certainty calculator circuit configured to calculate the degree of certainty,
a score calculator circuit configured to calculate the score, and
a converter circuit configured to output the conversion score.

18. An information processing method to be implemented by a computer, the method comprising:
calculating a degree of certainty expressed by a discrete value for each of one or more phrases included in a search criterion, the search criterion including the one or more phrases and one or more logical operators, the degree of certainty representing certainty of correlation between each of pieces of target information to be searched for and the one or more phrases;
calculating a score for each of the one or more phrases, the score being a continuous value obtained by converting degrees of similarity between the pieces of target information and the one or more phrases, the score being calculated such that the degrees of similarity fall within a range determined for the degree of certainty; and
converting the score calculated for each of the one or more phrases into a conversion score in accordance with a conversion method determined for each of the one or more logical operators.

19. A computer program product comprising a non-transitory computer-readable recording medium on which a computer program is recorded, the program instructing the computer to:
calculate a degree of certainty expressed by a discrete value for each of one or more phrases included in a search criterion, the search criterion including the one or more phrases and one or more logical operators, the degree of certainty representing certainty of correlation between each of pieces of target information to be searched for and the one or more phrases;
calculate a score for each of the one or more phrases, the score being a continuous value obtained by converting degrees of similarity between the pieces of target information and the one or more phrases, the score being calculated such that the degrees of similarity fall within a range determined for the degree of certainty; and
convert the score calculated for each of the one or more phrases into a conversion score in accordance with a conversion method determined for each of the one or more logical operators.
